(19) United States
(12) Patent Application Publication
(10) Pub. No.: US 2005/0010746 A1
(43) Pub. Date: Jan. 13, 2005

(54) METHOD FOR DYNAMICALLY BUILDING ACPI ARCHITECTURE

(76) Inventors: Yi-Chang Chen, Taipei Hsien (TW); Chih-Hsuan Wu, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,762

(22) Filed: Oct. 24, 2003

(30) Foreign Application Priority Data
Jul. 7, 2003 (TW) 092118525

(51) Int. Cl. G06F 15/177

(52) U.S. Cl. 713/1

(57) ABSTRACT

A method for building an ACPI architecture according to an ID code of a device connected to a bus during the booting period of a computer system. The method includes: (a) storing ASL codes of a plurality of the same type of devices in the BIOS of the computer system; (b) detecting the ID code of the device type connected to the computer system during the POST period; (c) loading the ASL code corresponding with the ID code detected in step (b) to a memory of the computer system, and ceasing to load ASL codes having ID codes not detected in step (b) to the memory of the computer system.

### BACKGROUND OF INVENTION

1. Field of the Invention

The present invention relates to a method for building an ACPI architecture, and more particularly, to a method for building an ACPI architecture according to an ID code of a device connected to a bus during the booting period of a computer system.

2. Description of the Prior Art

With the rapid development of information technology, computer systems are playing an important role in modernizing many companies, which now are widely used in practically every industry. Due to the increase in data storage density, the improvement in clock speed, and the decrease in production costs, the manufacturing of portable computers has become a mainstream business in the computer industry.

Normally, when the computer is turned on, the computer system executes the power on Self Test (POST), plug and play test, hardware configuration and so on. After finishing the above operations, the computer system loads the operating system, and the operating system coordinates the hardware and software of the computer system according to the settings stored in the BIOS.

In current computer systems, especially notebook systems, programmers always store ASL codes (ACPI source language codes) relating to the hardware connected to the computer system in the BIOS of the computer system. The ASL codes allow the operating system of the computer system to build Advanced Configuration and Power Interface Tables corresponding to the ASL codes. Please refer to FIG. 1. FIG. 1 shows a flowchart illustrating a method for building the ACPI architecture according to the prior art. The method contains the following steps:

Step 100: Store the ASL codes relating to the hardware connected to the computer system in the BIOS of the computer system.

Step 102: During the booting period of the computer system, the computer system loads the ASL codes relating to the hardware connected to the computer system stored in the BIOS of the computer system to a memory of the computer system.

Step 104: The operating system of the computer system builds Advanced Configuration and Power Interface Tables according to the ASL codes loaded into the memory in step 102 and loads a driver corresponding to the related hardware according to the ACPI architecture.

However, in the above method for building ACPI architecture according to the prior art, if there are different devices that can both be connected to the same port in a computer system, programmers have to program different version of BIOS. For example, if there are two different VGA chips that can be connected interchangeably to the accelerated graphics port in a notebook computer, programmers have to program two different versions of BIOS for the two different VGA chips. Other peripheral devices connected to the notebook on identical ports cause the same problem. From manufacturers and programmers point of view, writing two versions of BIOS for one system is tedious and not very cost-effective. Furthermore, any device having ASL codes stored in BIOS is also shown in the ACPI tables and this can cause compatibly problems. For instance, assume there is an A device of an A company computer and a B device of a B company computer. The A device and the B device are not connected to the same port so programmers can write the source code for the A and B devices in the same BIOS and provide the same BIOS to the A and B company computers. However, this causes a problem in that the A company can see the B device in the ACPI tables of the A company computer and the B company can see the A device in the ACPI tables of the B company computer.

### SUMMARY OF INVENTION

It is therefore a primary objective of the claimed invention to provide a method for building an ACPI architecture according to an ID code of a device connected to a bus during the booting period of a computer system to solve the above-mentioned problems.

According to the claimed invention, a method for building an ACPI architecture according to an ID code of a device connected to a bus during the booting period of a computer system is disclosed. The method includes: (a) storing ASL codes of a plurality of the same type of device in the BIOS of the computer system; (b) detecting the ID code of the device type connected to the computer system during the POST period; (c) loading the ASL code corresponding with the ID code detected in step (b) to a memory of the computer system and not loading ASL codes having ID codes not detected in step (b) to the memory of the computer system.

It is an advantage of the claimed invention that the ASL codes corresponding with the ID code detected during the POST period are loaded dynamically for building the ACPI Architecture.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a flowchart illustrating a method for building the ACPI architecture according to the prior art.

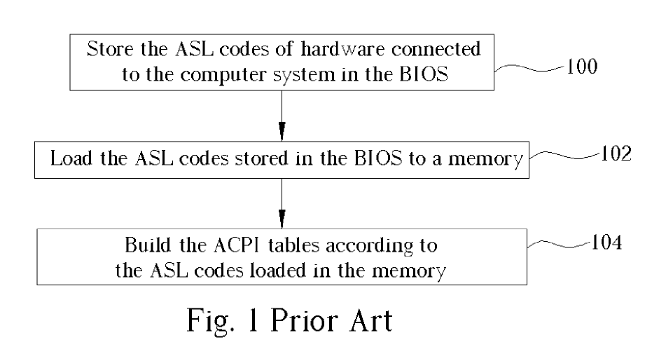

FIG. 2 is a block diagram of a computer system according to the present invention.

FIG. 3 is a memory map of the BIOS in FIG. 2 according to the present invention.

FIG. 4 is a flowchart illustrating a method for building the ACPI architecture to the present invention.

### DETAILED DESCRIPTION

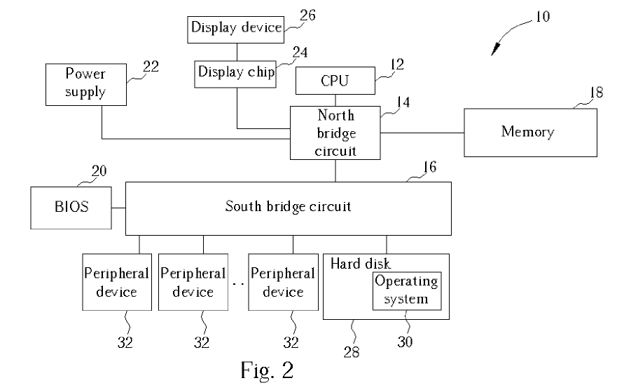

Please refer to FIG. 2. FIG. 2 is a block diagram of a computer system 10 according to the present invention. The computer system includes a CPU 12, a north bridge circuit 14, a south bridge circuit 16, a memory 18, a BIOS 20, a power supply 22, a display chip 24 electrically connected to the north bridge circuit 14, a display device 26 connected to the display chip 24, a hard disk 28 electrically connected to the south bridge circuit 16, an operating system 30 stored on the hard disk 28, and a plurality of peripheral devices 32 electrically connected to the south bridge circuit 16.

The CPU 12 is used for controlling each circuit in the computer system 10 to allow the computer system 10 to function normally. The north bridge circuit 14 is electrically connected to the CPU 12 and the memory 18 for managing data transmissions between the CPU 12 and the memory 18 as well as managing data transmissions between the CPU 12 and the display chip 24. The display device 26, for example a monitor, is electrically connected to the display chip 24 for displaying video data output from the display chip 24. The south bridge circuit 16 is electrically connected to the north bridge circuit 14 for exchanging data with the CPU 12 through the north bridge circuit 14. For example, the south bridge circuit 16 handles data transmission between the BIOS 20 and the CPU 12, data transmissions between the CPU 12 and the hard disk 28, and data transmissions between the CPU 12 and the peripheral devices 32. The peripheral device 32 could be a storage media (for example a floppy disk, CD-ROM, DVD-ROM, etc), an input device (for example a keyboard, mouse, etc), a printer, an audio device, a network device, and so on. The BIOS 20 is stored in a non-volatile memory and conducts the POST of the computer system 10 and loads the operating system 30 after finishing the POST. The memory is a random access memory (RAM) such as double data rate memory (DDR memory) for storing data. The power supply 22 is electrically connected to a power source with a predetermined voltage (for example 110 V) and converts the predetermined voltage to the operating voltage of the computer system 10.

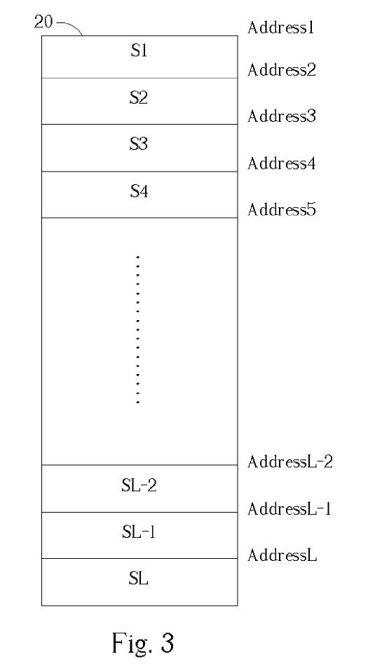

Please refer to FIG. 3. FIG. 3 shows a memory map of the BIOS 20 in FIG. 2 according to the present invention. The BIOS includes several sections of program code S1, S2, S3, . . . , SL, and each section of program code has a specific function and is stored at a specific memory address. For example the program code S2 is stored between address no.2 and address no.3. While the computer system 10 is turned on, the CPU uses the proper program code in the BIOS 20 for processing the hardware settings, controlling the hardware, and loading the operating system 30 to finish the booting procedure of the computer system 10.

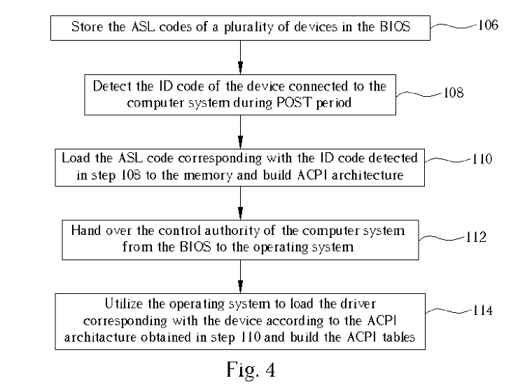

Please refer to FIG. 4. FIG. 4 is a flowchart illustrating a method for building the ACPI architecture according to the present invention. The flowchart contains the following steps:

Step 106: Store ASL codes of a plurality of the same type of devices in the BIOS 20 of the computer system 10.

Step 108: Detect the ID code of the device type connected to the computer system 10 during the POST period of the computer system 10.

Step 110: Load the ASL code corresponding with the ID code detected in step 108 to the memory 18 of the computer system 10 but do not load ASL codes having ID codes not detected in step 108 to the memory 18 of the computer system 10. Build the ACPI architecture according to the ASL codes loaded in the memory 18.

Step 112: Hand over the control authority of the computer system 10 from the BIOS 20 to the operating system 30 of the computer system 10 after finishing the BIOS 20 initialization.

Step 114: Utilize the operating system 30 to load a driver corresponding with the device type connected to the computer system 10 according to the ACPI architecture obtained in step 110 and build the ACPI Tables in the operating system 30.

The procedure for building the ACPI architecture according to the ID code of a device connected to a bus during the booting period of the computer system 10 is described in detail as follows. As an example, assume the plurality of ASL codes of the different brand display chips 24 connected to the accelerated graphics port are stored in the BIOS 20 as shown in the memory map of FIG. 3. During the POST period of the computer system 10, the computer system 10 detects the ID code of the display chip 24 connected to the accelerated graphic port, such as a PnP ID code. The ID code detected during the POST period is compared with ID codes in the plurality of the ASL codes stored in the BIOS 20 and only the ASL code corresponding with the ID code of the display chip 24 connected to the accelerated graphic port is found among the plurality of ASL codes stored in the BIOS 20. This means that the ASL code corresponding with the brand and type of the display chip 24 is found and loaded into the memory 18. The other ASL codes stored in the BIOS 20 are not loaded to the memory 18. Therefore the ACPI architecture relating the display chip 24 is built according to the ASL code of the display chip 24 loaded into the memory 18. The control authority is handed over from the BIOS 20 to the operating system 30 of the computer system 10 after finishing the BIOS 20 initialization. The operating system 30 then loads the driver corresponding with the display chip 24 connected to the computer system 10 according to the ACPI architecture obtained as mention above. Finally, the ACPI table is built in the operating system 30. Because the information of the display chip 24 shown in the ACPI Tables is provided after detection and stored in the corresponding ASL code, the correct information of the display chip 24 is shown in the ACPI Tables.

However, in step 106 the plurality of the same type of devices can be peripheral devices 32 connected to the same connection port as well as different connection ports. In the above-mentioned embodiment, the plurality of the-same type of devices were display chips that have to be connected to the accelerated graphic port, so only one corresponding ASL code could be loaded to the memory 18 and only one display chip information item is shown in the ACPI Tables built by the operating system 30. If there is a plurality of the same type of devices connected to different connection ports such as would occur if the computer system 10 contains either a network chip connected to a PCI port or a network chip connected to a USB port, the present invention can still be applied. In the first case, the network chip connected to the bus is detected to decide which network chip is connected to the PCI port or connected to the USB port and is installed in the computer system 10. The corresponding ASL code of the installed network device stored in the BIOS 20 are loaded to the memory 18. In the second case, if the computer system includes two network chips, the first connected to the PCI and the second connected to the USB port, the two sets of ASL codes stored in the BIOS 20 are loaded to the memory 18 and the information of the two network chips is shown in the ACPI Tables built by the operating system 30.

In addition, programmers can decide how many ASL codes for the plurality of the same type devices stored in the BIOS 20. This is a design choice and the number is not limited to two sets as mention above.

In contrast to the prior art, the present invention provides a method for building the ACPI architecture according to an ID code of a device connected to a bus during the booting period of the computer system 10. Because in the present invention the ASL codes corresponding with the ID code detected during the POST period are loaded dynamically to the memory 18 for building ACPI Architecture, the problem that programmers have to program different editions of BIOS if there are different devices connected to the same port in different computer systems is solved. Additionally, in the prior art, because the ASL codes stored in the BIOS are all loaded to the memory, devices whose ASL codes are stored in the BIOS are shown in the ACPI Tables of the operating system, causing a problem that the wrong device is shown in the ACPI Tables. In the present invention, the method includes detecting the ID code of the hardware device connected to the computer system 10 during the POST period and loading the ASL codes of the installed hardware device to the memory 18. In this way, the ACPI Tables display the hardware devices actually installed in the computer system and will not display the other hardware devices whose ASL codes are also stored in the BIOS.

Those skilled in the art will readily observe that numerous modifications and alterations of the method may be made while retaining the teachings of the invention. Accordingly, the above disclosure should be construed as limited only by the metes and bounds of the appended claims.

1. A method for building an ACPI architecture according to an ID code of a device connected to a bus during the booting period of a computer system, the method comprising:
(a) storing ASL codes of a plurality of the same type of devices in the BIOS of the computer system:
(b) detecting the ID code of the device type connected to the computer system during the POST period;and (c) loading the ASL code corresponding with the ID code detected in step (b) to a memory of the computer system and not loading ASL codes having ID codes not detected in step (b) to the memory of the computer system.

2. The method of claim 1 wherein the ID code in step (b) and (c) is a PnP ID code.

3. The method of claim 1 further comprising handing over the control authority of the computer system from the BIOS to an operating system of the computer system after finishing the BIOS initialization, utilizing the operating system to load a driver corresponding with the device type connected to the computer system according to the ACPI architecture obtained in step (c), and building ACPI Tables in the operating system.

4. The method of claim 1 wherein in step (a) the type of the device is a display chip.

5. The method of claim 1 wherein in step (c) the memory of the computer system is a random access memory (RAM).

6. The method of claim 1 wherein the BIOS is stored in a non-volatile memory.
